(19) United States
(12) Patent Application Publication
(10) Pub. No.: US 2021/0142265 A1
(43) Pub. Date: May 13, 2021

(54) System and Method for Orderfilling Trip Allocation

(71) Applicant: Walmart Apollo, LLC, Bentonville, AR (US)

(72) Inventors: Michael Thao, Bentonville, AR (US); Patricio A. Hudson, New York, NY (US); Javier Blanco, Centerton, AR (US); Zachary Watts, Red Bluff, CA (US)

(21) Appl. No.: 17/092,552

(22) Filed: Nov. 9, 2020

Related U.S. Application Data
(60) Provisional application No. 62/932,640, filed on Nov. 8, 2019.

(51) Int. Cl. G06Q 10/08; G06Q 10/06; G02B 27/01

(52) U.S. Cl. CPC G06Q 10/087; G06Q 10/06395; G02B 2027/0178; G02B 27/017; G06Q 10/063112

(57) ABSTRACT

Systems and method for allocating orderfilling trips in a facility are discussed. Available trips are categorized for difficulty based on specifically defined criteria and mapped to tenure groups. The amount of worker experience for each available facility worker is used to assign each available facility worker to a tenure group. Available mapped trips are allocated to facility workers belonging to the same tenure group. Trip performance verification may be accomplished in real-time using client devices assigned to a facility worker.

### RELATED APPLICATION

This application claims priority to, and the benefit of, U.S. Provisional Patent Application No. 62/932,640, entitled “Systems And Method For Orderfilling Trip Allocation”, filed on Nov. 8, 2019, the content of which is hereby incorporated by reference in its entirety.

### BACKGROUND

Distribution centers and other storage facilities store products until the products are ordered and then distribute the products for orders via trucks or other delivery modalities to retail stores or other destinations. This order satisfaction process, referred to “orderfilling”, requires that the specific products for the order be retrieved from their storage locations by facility workers and delivered to a loading area. Once at the loading area the products are frequently wrapped on pallets before being loaded into a truck, shipping container or other transport modality for delivery. To assist with the loading process, the orders frequently must be delivered to the loading area in a specified sequence and satisfy specified time constraints

### BRIEF SUMMARY

In one embodiment, a system for orderfilling trip allocation includes one or more databases holding historical trip performance data, facility worker data and available trip data. The system further includes a computing device equipped with at least one processor and configured to execute an allocation module. When executed, the allocation module identifies a number of available trips to be allocated during a defined time period in a facility using the available trip data and ranks each available trip for difficulty based on characteristics of each available trip using the historical trip performance data. The allocation module when executed additionally identifies available facility workers in the facility during the defined time period using the facility worker data and assigns each available facility worker to a tenure category based on an amount of time the facility worker has worked at the facility. The allocation module maps each ranked available trip to a tenure category and allocates a mapped trip to an available facility worker that is assigned to the same tenure category.

In another embodiment, a computing-device implemented method for orderfilling trip allocation includes the step of identifying a number of available trips to be allocated during a defined time period in a facility using the available trip data. The method further includes ranking each available trip for difficulty based on characteristics of each available trip using the historical trip performance data and identifying available facility workers in the facility during the defined time period using the facility worker data. The method also includes assigning each available facility worker to a tenure category based on an amount of time the facility worker has worked at the facility and mapping each ranked available trip to a tenure category. The mapped trip is then allocated to an available facility worker that is assigned to the same tenure category.

### BRIEF DESCRIPTION OF THE DRAWINGS

The accompanying drawings, which are incorporated in and constitute a part of this specification, illustrate one or more embodiments of the invention and, together with the description, help to explain the invention. In the drawings:

FIG. 1 depicts trip ranking matrices produced for an exemplary embodiment;

FIG. 2 depicts an allocation matrix assigning ranked trips to tenure categories in an exemplary embodiment;

FIG. 3 depicts an exemplary sequence of steps for performing orderfilling trip allocation in an exemplary embodiment;

FIG. 4 depicts an exemplary computing device suitable for use in an exemplary embodiment; and

FIG. 5 depicts an exemplary facility environment in an exemplary embodiment.

### DETAILED DESCRIPTION

Distribution centers, and other facilities that perform orderfilling, typically include a large number of aisles in a warehouse-type setting. These aisles include multiple modular locations, referred to herein as “slots” or “slot locations”, that are frequently arranged as a series of shelving units. Product cases are often stored on these shelving units. The product cases have varying weights depending upon the type of product. Facility workers, who are also referred to herein as “orderfillers” are assigned to retrieve the product cases, frequently with the aid of pallet jacks pulled by the facility worker which typically come in one or two pallet configurations. To fill an order to load a truck or other delivery container, the order is broken up into multiple parts containing lists of products to retrieve. Each of these parts of the order is assigned to a different facility worker and requires a traversal of the facility by the orderfiller which is referred to herein as a “trip”. When the orderfiller arrives at a location in the facility of a product needed for the trip he or she moves one or more cases of the product to the pallet jack as required. It will be appreciated that the number of aisles traversed, the number of locations/slots visited in the aisles, the number of product cases retrieved and the weight of the product cases during a trip will vary based upon the particular requirements of the trip.

In one embodiment, a delivery order may be segmented into multiple orderfilling trips that need to be performed by multiple facility workers. The facility workers will vary in experience levels as some will have worked longer at the facility than others. The initial segmentation of the order that is done prior to allocation may be done subject to a number of constraints including, but not limited to, weight, volume, product type and location constraints. For example, different products in an order that are physically located in close proximity within the facility may be combined into a single trip. Likewise similar types of products (frozen goods, perishable produce or general merchandise) may also be grouped into a single trip. Regardless of the particular mechanism used for dividing the order, once the order has been divided into multiple trips (i.e. available trips); an allocation module is executed that examines the individual available trips for pre-specified characteristics. In one embodiment, the characteristics of the trip are the number of aisles required to be traversed, the number of locations/slots required to be visited in the aisles, the number of product cases retrieved and the weight of the product cases in the trip. Using historical performance data (i.e. data from past trips performed), it can be seen that trips with particular values for these characteristics are expected to take certain amounts of time to complete with some trips being more difficult than others. Accordingly, in one embodiment, each characteristic for a particular trip (e.g. the trip will require eight aisles to be traversed, one hundred and ten cases to be retrieved, at seven locations and the products will weigh three hundred pounds) is assigned a separate difficulty category and the combination provides an overall difficulty ranking for the trip.

FIG. 1 depicts trip ranking matrices produced during the trip difficulty ranking process for an exemplary embodiment. The available trips for a delivery order may be examined for four separate characteristics: aisles 101, product cases 102, slot locations 103 and weight 104. More particularly, the allocation module may examine an available trip using facility layout data and product data to determine how many aisles must be traversed and thus how far the orderfiller must walk, how many slot locations must be visited, how many product cases must be retrieved and how much those cases weigh and assign a difficult ranking category for each of the characteristics. For example, the allocation module may assign one of five difficulty categories for each characteristic for a trip such as A to E with A being the easiest trip historically and E being the hardest. It will be appreciated that the labels for the categories are illustrative and other ranking systems (1 to 5, decimal values etc.) may be used to provide a relative ranking of the trips. Similarly, it should be appreciated that a greater or lesser number of characteristics may be evaluated when determining trip difficulty. For example, in one embodiment only aisles traversed and product cases retrieved may be considered.

As illustrated, FIG. 1 depicts two separate available trip difficulty ranking matrices 111, 112 based on historical performance data for the four characteristics: aisles 101, product cases 102, slot locations 103 and weight 104. A single pallet matrix 111 provides trip difficulty rankings for single pallet trips in which the pallet jack has a single pallet while a double pallet matrix 112 provides trip difficulty rankings performed by orderfillers equipped with a double pallet jack. With reference to single pallet matrix 111 it will be observed that available trips requiring eight or fewer aisles to be traversed by the facility worker are considered easier trips and therefore assigned a difficulty category of ‘A’ while trips requiring 15 or more aisles to be traverses are considered to be the hardest trips and assign a difficulty category of ‘E’. It will be appreciated that the relative rankings are a result of the distance which the orderfiller must traverse to complete the trip, longer trips take more time and are considered more difficult. Similarly available trips that require the retrieval of one hundred product cases may be considered to be moderately difficult and therefore assigned a difficulty category of ‘C’ in comparison to trips that require the retrieval of a lesser number of product cases and are considered easier and trips that require the retrieval of a greater number of product cases and are considered harder.

The individual scores for the separate characteristics are combined to form an overall difficulty category ranking for an available trip. With reference to FIG. 1, an available trip requiring the traversal of five aisles, to retrieve eighty product cases at ten slot locations with a “weight/cube”, weight per cubic foot, of ten would be ranked as an ABAA difficulty trip, one of the easiest possible available trips (the weight cube parameter is used to approximate how dense and easy to handle the box is based on weight and size. As will be explained further below, such a trip may be most appropriate for allocation to a newer facility worker. Once all of the available trips have been ranked, the ranked available trips are mapped by the allocation module to different facility worker tenure categories so as to map more difficult trips to more experienced facility workers and map less difficult trips to less experienced facility workers. The exact number of worker tenure categories is an implementation choice in the orderfilling system as is the experience level dividing the categories. The mapping of the ranked available trips can take a number of different forms. In one embodiment, the ranked trips are mapped to the tenure categories based as evenly as possible across the tenure categories. For example if the order includes twenty-five separate available trips, the five easiest available trips may be mapped to the least experienced tenure category, the next five harder trips may be mapped to the second least experienced tenure category etc. In another embodiment, the trips may be mapped to tenure categories solely on the basis of historical performance data regardless of whether it results in an uneven allocation across tenure categories (it will be appreciated that this approach may present a problem with the eventual trip allocation to orderfillers if not enough experienced workers are available at the facility during the time period in which the order must be filled).

FIG. 2 depicts an allocation matrix assigning ranked trips to tenure categories in an exemplary embodiment. The allocation matrix includes five tenure categories 202, 204, 206, 208 and 210. As a non-limiting example, tenure category 202 may indicate trips appropriate for workers with at least one week experience at the facility, tenure category 204 may indicate trips appropriate for workers with at least four weeks experience at the facility, tenure category 206 may indicate trips appropriate for workers with at least seven weeks experience at the facility, tenure category 208 may indicate trips appropriate for workers with at least ten weeks experience at the facility, and tenure category 210 may indicate trips appropriate for workers with at least fourteen weeks experience at the facility. As the tenure categories increase in experience level, more trips are available to the orderfiller. As illustrated in FIG. 2, in tenure category (202) 61% of available trips in an order are allocable to workers in the tenure category. Similarly, in tenure category (204) 84% of available trips are allocable to workers in the tenure category, in tenure category (206) 95% of available trips are allocable to workers in the tenure category, in tenure category (208) 97% of available trips are allocable to workers in the tenure category, and in tenure category (210) 98% of available trips are allocable to workers in the tenure category. In this manner, embodiments provide an automatic allocation of trips to workers having an appropriate experience level for the trip. Such an appropriate allocation can lead to both worker retention and more efficient processing of orders as workers should be able to complete the trip successfully and the products should arrive at the loading area on time in order to load the delivery vehicles. It should be appreciated that the parameters for the tenure categories utilized by the allocation module may be configurable by an authorized facility administrator to take into account an available facility worker pool and/or changing observed performance data.

In one embodiment, the trip characteristics are equally weighted in determining an overall difficulty ranking for an available trip. For example, an AAAB trip difficulty ranking may be processed by the allocation module in an equally weighted numerical manner (with A=1, B=2, C=3, D=4 and E=5) as 1+1+1+2/4=1.25 trip difficulty ranking. In another embodiment, some characteristics may be weighted more than others to determine the overall trip difficulty ranking. For example, using the four characteristics discussed above, an alternate embodiment in which aisles traversed and product cases retrieved are given twice the weight of the other characteristics may be calculated for a BABA ranked trip as (2*2)+(1*2)+2+1/4=9/4=2.25 trip difficulty ranking.

FIG. 3 depicts an exemplary sequence of steps for performing orderfilling trip allocation in an exemplary embodiment. The exemplary sequence begins with the identification of available trips for an order (step 302). The allocation module is executed to rank the difficulty of each trip (step 304). In one embodiment the allocation module individually ranks each of four trip characteristics for difficulty and uses the individual rankings to rank the entire available trip. The allocation module also identifies a tenure category for each available facility worker (step 306) using facility worker data retrieved from one or more databases. For example, the allocation module may identify which workers are at the facility during a specific time period such as an overnight shift during which the orderfilling trip is to take place and then identify the tenure of those workers. Each ranked available trip is then mapped to a tenure category (step 308). As noted above, the available trips may be equally mapped among a pre-determined number of tenure categories or may be specifically assigned to tenure categories based on historical performance data regardless of whether such a mapping results in an uneven distribution. The allocation module then allocates each mapped available trip to a facility worker/orderfiller whose tenure matches the trips's tenure category (step 310).

In one embodiment a notification of the allocation of each available trip may be transmitted by the server or other computing device executing the allocation module to a client device associated with the facility manager so that the manager may inform the particular facility worker to whom the trip has been allocated. In another embodiment, the allocation of each available trip may be transmitted by the server or other computing device executing the allocation module to a client device associated with the facility worker to whom the trip is assigned. In a further embodiment, a facility manager may interact with the allocation module via a GUI on their client device to request a trip for a particular facility worker. The allocation module receives the request, verifies which tenure category the worker belongs to, and then allocates an available mapped trip from that tenure category to the worker and transmits a notification to that effect back to the requesting manager. In a further embodiment, the facility worker may interact with the allocation module via a GUI on their client device to request a trip for themselves when available and the allocation module may allocate a trip and respond directly to the worker.

FIG. 4 depicts an exemplary computing device suitable for use in an exemplary embodiment. The computing device 400 includes one or more non-transitory computer-readable media for storing one or more computer-executable instructions or software for implementing exemplary embodiments. The non-transitory computer-readable media can include, but are not limited to, one or more types of hardware memory, non-transitory tangible media (for example, one or more magnetic storage disks, one or more optical disks, one or more USB flash drives), and the like. For example, memory 408 included in the computing device 400 can store computer-readable and computer-executable instructions or software for implementing exemplary embodiments. The computing device 400 also includes processor 406 and associated core(s) 420, and optionally, one or more additional processor(s) (not shown), in the case of computer systems having multiple processors/cores, for executing computer-readable and computer-executable instructions or software stored in the memory 408 and other programs for controlling system hardware. Processor 406 and can be a single core processor or multiple core processor.

Memory 408 can include a computer system memory or random access memory, such as DRAM, SRAM, EDO RAM, and the like. Memory 408 can include other types of memory as well, or combinations thereof. An individual can interact with the computing device 404 through a visual display device 402, such as a touch screen display or computer monitor, which can display one or more user interfaces for displaying data to a user (e.g., a display of a storage device in the distributed store connected to the computing device 404 via network interface 410 and software running on the storage device that is the cause of an error in imported data). The visual display device 402 can also display other aspects, elements and/or information or data associated with exemplary embodiments. The computing device 404 can include other I/O devices for receiving input from an individual, for example, a keyboard or another suitable multi-point touch interface, a pointing device (e.g., a pen, stylus, mouse, or trackpad). The keyboard and the pointing device can be coupled to the visual display device 402. The computing device 404 can include other suitable conventional I/O peripherals.

The computing device 404 can also include one or more storage devices 416, such as a hard-drive, CD-ROM, or other computer readable media, for storing data and computer-readable instructions and/or software, such as one or more modules of the allocation module that implements exemplary embodiments of the system as described herein, or portions thereof, and which can be executed to generate a graphical user interface (GUI), such as one or more of GUIs on visual display device 402. Exemplary storage devices 416 can also store one or more databases for storing suitable information required to implement exemplary embodiments. The databases can be updated by an individual or automatically at a suitable time to add, delete or update one or more items in the databases. Exemplary storage devices 416 can store one or more databases 418 for storing provisioned data, and other data/information used to implement exemplary embodiments of the systems and methods described herein.

The computing device 404 can include a network interface 410 configured to interface via one or more network devices 414 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. The network interface 404 can include a built-in network adapter, network interface card, PCMCIA network card, card bus network adapter, wireless network adapter, USB network adapter, modem or another device suitable for interfacing the computing device 404 to a type of network capable of communication and performing the operations described herein. Moreover, the computing device 404 can be a computer system, such as a workstation, desktop computer, server, laptop, handheld computer, tablet computer (e.g., the iPad® tablet computer), mobile computing or communication device (e.g., the iPhone® communication device), or other form of computing or telecommunications device that is capable of communication and that has sufficient processor power and memory capacity to perform the operations described herein.

The computing device 404 can run an operating system 412, such as versions of the Microsoft® Windows® operating systems, the different releases of the Unix and Linux operating systems, a version of the MacOS® for Macintosh computers, an embedded operating system, a real-time operating system, an open source operating system, a proprietary operating system, an operating systems for mobile computing devices, or another operating system capable of running on the computing device and performing the operations described herein. In exemplary embodiments, the operating system 412 can be run in native mode or emulated mode. In an exemplary embodiment, the operating system 412 can be run on one or more cloud machine instances.

FIG. 5 depicts an exemplary facility environment suitable in an exemplary embodiment. The facility 500 includes facility workers/orderfillers (not shown) available to perform orderfilling trips. Client devices 501, 502, 503 which may be various forms of computing devices equipped with one or more processors and are communicatively coupled to a facility computing device such as server 540, may be individually associated with facility workers and provide verification of trip performance by the facility workers. For example, client devices 501, 502, 503 may verify performance of individual tasks during an orderfilling trip (e.g. traversal of an aisle, retrieval of a product case) and track start and completion time using internal sensors such as GPS, accelerometers and internal clocks. Such data may be used to provide real-time verification of orderfiller performance and improve overall system functionality by providing additional performance data. In one embodiment, client devices 501, 502 and 503 may enable facility workers to receive trip assignments from allocation module 541 that are allocated in the manner described above. Client device 501, 502, 503 may alternatively be associated with a manager of the facility workers and enable communication with allocation module 541 over network 530 to allocate trips to facility workers with the manager informing the individual facility workers of their assigned trips. Network 530 may take different forms including without limitation, a local area network, wide area network, an intranet, the Internet or a cellular network. In one embodiment, the manager may initiate a trip allocation performance by allocation module 541 for a particular facility worker via a provided GUI on client device 501, 502 or 503.

Allocation module 541 may execute on server 540 and use historical trip performance data 551, facility worker data 552, available trip data 553, facility data 554 and product data 555 retrieved from database 550 to allocate trips to facility workers in the manner described herein. Historical trip performance data 551 may include, but is not limited to, past time performances of orderfilling trips having specified numbers of aisles, product cases, slot locations and product weight. The performance data may be indexed by worker tenure. Facility worker data 552 may include, but is not limited to, data identifying workers available during specified time periods and the worker's work tenure at the facility. Available trip data 553 may include, but is not limited to, available trips that need to be filled that are part of a facility order. Facility data may include, but is not limited to, layout data indicating where aisles and slot locations are located in a facility and product location data indicating where products are stored. Product data 555 may include, but is not limited to, size and weight information for various products. It will be appreciated that a number of constraints may be utilized in dividing an order into multiple trips including, but not limited to, product type (e.g. perishable, frozen or general merchandise products), scheduled shipping modality arrival and departure times (e.g. refrigerated truck arriving at 7 am and departing by 9 am), number of available facility workers, the experience level of facility workers and/or the size of the available pallet jacks.

Embodiments of the present invention make use of historic trip performance data to rank trips by difficulty based on pre-defined criteria and then allocate those trips to facility workers based on tenure. In one embodiment, trips for an order are ranked based on four factors, the number of aisles the facility worker must traverse, the number of locations in those aisles that must be visited, the number of product cases to be retrieved and the weight of those product cases. It should be appreciated that other criteria or a subset of these four factors may also be used to rank the trips without departing from the scope of the present invention.

Portions or all of the embodiments of the present invention may be provided as one or more computer-readable programs or code embodied on or in one or more non-transitory mediums. The mediums may be, but are not limited to a hard disk, a compact disc, a digital versatile disc, ROM, PROM, EPROM, EEPROM, Flash memory, a RAM, or a magnetic tape. In general, the computer-readable programs or code may be implemented in any computing language.

Since certain changes may be made without departing from the scope of the present invention, it is intended that all matter contained in the above description or shown in the accompanying drawings be interpreted as illustrative and not in a literal sense. Practitioners of the art will realize that the sequence of steps and architectures depicted in the figures may be altered without departing from the scope of the present invention and that the illustrations contained herein are singular examples of a multitude of possible depictions of the present invention.

The foregoing description of example embodiments of the invention provides illustration and description, but is not intended to be exhaustive or to limit the invention to the precise form disclosed. Modifications and variations are possible in light of the above teachings or may be acquired from practice of the invention. For example, while a series of acts has been described, the order of the acts may be modified in other implementations consistent with the principles of the invention. Further, non-dependent acts may be performed in parallel.

We claim:

1. A system for orderfilling trip allocation, comprising:
one or more databases holding historical trip performance data, facility worker data and available trip data;
a computing device equipped with at least one processor and configured to execute an allocation module that when executed:
identifies a number of available trips to be allocated during a defined time period in a facility using the available trip data,
ranks each available trip for difficulty based on characteristics of each available trip using the historical trip performance data;
identifies available facility workers in the facility during the defined time period using the facility worker data,
assigns each available facility worker to a tenure category based on an amount of time the facility worker has worked at the facility,
maps each ranked available trip to a tenure category, and
allocates a mapped trip to an available facility worker that is assigned to the same tenure category.

2. The system of claim 1, wherein the characteristics of each available trip include a number of aisles in the trip, a number of slot locations in the aisles, a number of product cases to be retrieved by the facility worker, and a weight of the product cases to be retrieved during the trip.

3. The system of claim 1, further comprising:
a plurality of client devices each associated with an available facility worker and operable to verify performance of an allocated trip, each client device communicatively coupled to the computing device.

4. The system of claim 3 wherein the plurality of client device are operable to verify correct aisle location, correct slot location, correct product and correct amount of product during a trip.

5. The system of claim 3 wherein the plurality of client devices are smart glasses.

6. The system of claim 1, wherein the allocation module when executed maps the least difficult available trips to a tenure category associated with available facility workers with the least amount of time at the facility.

7. The system of claim 1 further comprising:
a client device associated with a manager in the facility and communicatively coupled to the computing device,
wherein information regarding the allocated mapped trip is automatically transmitted by the allocation module to the client device associated with the manager.

8. The system of claim 1 further comprising:
a client device associated with an available facility worker and communicatively coupled to the computing device,
wherein information regarding the allocated mapped trip is automatically transmitted to the client device associated with the available facility worker.

9. A computing-device implemented method for orderfilling trip allocation, comprising:
identifying a number of available trips to be allocated during a defined time period in a facility using the available trip data,
ranking each available trip for difficulty based on characteristics of each available trip using the historical trip performance data;
identifying a tenure category for each available facility workers in the facility during the defined time period using the facility worker data, the tenure category based on an amount of time the facility worker has worked at the facility;
mapping each ranked available trip to a tenure category, and
allocating a mapped trip to an available facility worker that is assigned to the same tenure category.

10. The method of claim 9, wherein the characteristics of each available trip include a number of aisles in the trip, a number of slot locations in the aisles, a number of product cases to be retrieved by the facility worker, and a weight of the product cases to be retrieved during the trip.

11. The method of claim 9, wherein a plurality of client devices are each associated with an available facility worker and operable to verify performance of an allocated trip, each client device communicatively coupled to the computing device.

12. The method of claim 11, further comprising:
verifying a correct aisle location, a correct slot location, a correct product or a correct amount of product during a trip using the plurality of client devices.

13. The method of claim 11 wherein the plurality of client devices are smart glasses.

14. The method of claim 9, further comprising:
mapping the least difficult available trips to a tenure category associated with available facility workers who have worked the least amount of time at the facility.

15. The method of claim 9, wherein a client device is associated with a manager in the facility and communicatively coupled to the computing device, and further comprising:
transmitting automatically information regarding the allocated mapped trip to the client device associated with the manager.

16. The method of claim 9, wherein a client device is associated with an available facility worker and communicatively coupled to the computing device, and further comprising transmitting automatically information regarding the allocated mapped trip to the client device associated with the available facility worker.

17. A non-transitory medium holding computing-device executable instructions for orderfilling trip allocation, the instructions when executed causing at least one computing device to:
identify a number of available trips to be allocated during a defined time period in a facility using the available trip data,
rank each available trip for difficulty based on characteristics of each available trip using the historical trip performance data;
identify available facility workers in the facility during the defined time period using the facility worker data,
assign each available facility worker to a tenure category based on an amount of time the facility worker has worked at the facility,
map each ranked available trip to a tenure category, and
allocate a mapped trip to an available facility worker that is assigned to the same tenure category.

18. The medium of claim 17, wherein the characteristics of each available trip include a number of aisles in the trip, a number of slot locations in the aisles, a number of product cases to be retrieved by the facility worker, and a weight of the product cases to be retrieved during the trip.

19. The medium of claim 17, wherein a plurality of client devices are each associated with an available facility worker and operable to verify performance of an allocated trip, each client device communicatively coupled to the computing device.

20. The medium of claim 17, wherein the instructions when executed further cause the at least one computing device to:
verify a correct aisle location, a correct slot location, a correct product or a correct amount of product during a trip using the plurality of client devices.
